(19) United States
(12) Patent Application Publication
(10) Pub. No.: US 2013/0011671 A1
(43) Pub. Date: Jan. 10, 2013

(54) ARTICLE AND AN ADHESIVE FOR A ROLL-SHAPED PAPER

(76) Inventors: CHIHO FUJITA, Osaka (JP); Takehiro Imanishi, Osaka (JP)

(21) Appl. No.: 13/613,394

(22) Filed: Sep. 13, 2012

Related U.S. Application Data
(63) Continuation of application No. PCT/US2011/028992, filed on Mar. 18, 2011.

(30) Foreign Application Priority Data
Mar. 30, 2010 (JP) 2010-078560

(51) Int. Cl. C09J 105/00; B32B 7/12; C08L 5/00; C09J 139/06; C09J 171/02

(52) U.S. Cl. 428/355 CP; 524/58; 524/56

(57) ABSTRACT

This invention provides an adhesive for roll-shaped paper which has a high initial adhesiveness and causes the paper to peel easily without making the application surface sticky, and a roll-shaped paper on which this adhesive for roll-shaped paper is applied. An adhesive for roll-shaped paper, comprising a saccharide (A), a viscosity modifier (B), and a glycol and/or triol (C), is provided. The adhesive has excellent initial adhesiveness as well as excellent peeling ability, and does not produce stickiness. The adhesive for roll-shaped paper of this invention is applied at the start of the winding of the roll-shaped paper and it can be used in an especially useful manner as a pick-up agent.

### CROSS-REFERENCE TO RELATED APPLICATIONS

This application is a continuation of International Patent Application No. PCT/US2011/028992 filed Mar. 18, 2011, which claims priority to Japanese Patent Application No. 2010-078560 filed Mar. 30, 2010, the contents of both of which are incorporated herein by reference.

This invention concerns roll-shaped papers such as toilet paper and kitchen towels and an adhesive for roll-shaped paper which is applied to roll-shaped papers, in particular an adhesive which is applied at the start of the winding of the paper (a so-called pick-up agent).

“Roll-shaped papers” are paper products in which papers, e.g., kitchen paper, paper blotting cloths, wrapping papers, toilet paper, paper towels, etc., are wound in roll form; they may have cores or not have cores. Roll-shaped papers with cores are made by loosely winding the paper on a tubular core (paper tube) and winding it up in such a way that the paper has the desired length and outer diameter. Roll-shaped papers without cores are products in which the paper is loosely wound on a narrow winding core (winding axis) and then firmly wound, to make a product with the desired length and outer diameter; after this, the winding core is removed. Alternatively, the paper may be firmly wound on a winding core with the same diameter as the tubular core of the type which has a core, making a product with the desired length and outer diameter, after which the winding core is removed.

When roll-shaped papers are manufactured, whether ones with cores or without cores, a special adhesive, called a “pick-up agent,” is applied to the part of the paper where the winding is started, adhering the core (for example, a tubular core or winding core, especially paper cores) and the paper.

The pick-up agent must have the following performances: 1) after the pick-up agent has been applied to the core, the core and the paper which is wound in a roll shape can be quickly adhered while the adhesive is wet and not yet dried; and 2) after the pick-up agent has dried, the adhered paper can be easily peeled from the core. Therefore, the pick-up agent must have both excellent adhesiveness while it is wet (referred to below as “initial adhesiveness”) and also excellent peeling ability after it has dried (referred to below as “peeling ability”).

Conventional pick-up agents have water, polyvinyl alcohols, ethyl cellulose, polyvinyl acetate, alkyl resins, etc., as their principal ingredients. However, since these pick-up agents have initial adhesivenesses which are too high, there is the problem that their peeling abilities are insufficient. Therefore, the method of adding peeling adjustment agents to the pick-up agents in order to improve their peeling abilities is known (see, for example, Patent References 1 and 2).

For example, Japanese Patent Application No. 2005-261736 discloses a pick-up agent in which fatty acid esters and fatty acid amides are added as peeling adjustment agents to a paste the principal ingredient of which is a saccharide such as a starch. Moreover, Japanese Patent Application No. 2005-272084 discloses the use of polyalkylene glycols as peeling adjustment agents.

Since the pick-up agents disclosed in Patent References 1 and 2 contain pick-up agents, they have excellent peeling abilities and the paper can therefore be easily peeled off of the core, but the initial adhesiveness is insufficient. Since the adhesive forces of pick-up agents with poor initial adhesivenesses are low when they are wet, even though they are applied to the place where the winding of the roll-shaped paper is started, there is the problem that the core and the paper cannot be adhered (that is, picked up).

If the quantity of the pick-up agent added is limited in order to obtain a balance of the initial adhesiveness and peeling ability of the pick-up agent, the application surface of the roll-shaped paper becomes sticky and the peeling ability is lowered.

This invention provides an adhesive for roll-shaped paper which has a high initial adhesiveness and causes the paper to peel easily without making the application surface sticky (in particular, a pick-up agent) and a roll-shaped paper on which this adhesive for roll-shaped paper is applied.

Therefore, it has been discovered that adhesives in which specific aqueous polymers and specific compounds are added to saccharides which contain glucose do not produce “stickiness” and have excellent initial adhesiveness and excellent peeling ability, and they are especially useful as pick-up agents.

One embodiment provides an adhesive for roll-shaped paper which is characterized by the fact that it comprises a saccharide (A), a viscosity modifier (B), and a glycol and/or triol (C), wherein

(A) the saccharide contains glucose, and

(B) the viscosity modifier contains aqueous polymers with weight average molecular weights in the range of 20,000-4,000,000.

Another embodiment of the invention provides adhesive for roll-shaped paper wherein the saccharide (A) also contains maltose.

Yet another embodiment of the invention provides an adhesive for roll-shaped paper, wherein the aqueous polymers with weight average molecular weights in the range of 20,000-4,000,000 are vinyl pyrrolidone polymers with weight average molecular weights in the range of 25,000-400,000 and/or alkylene oxide polymers with weight average molecular weights in the range of 300,000-3,500,000.

In a desirable embodiment, this invention provides an adhesive for roll-shaped paper which is applied at the start of the winding of the roll-shaped paper.

In a further embodiment, the invention provides a roll-shaped paper to which the aforementioned adhesive for roll-shaped paper is applied.

It is desirable for the roll-shaped paper to have the aforementioned adhesive for roll-shaped paper applied to it at the start of the winding.

Since the adhesive for roll-shaped paper of this invention is an adhesive for roll-shaped paper which comprises a saccharide (A), a viscosity modifier (B), and a glycol and/or triol (C):

(A) the saccharide contains glucose, and

(B) the viscosity modifiers include aqueous polymers with weight average molecular weights in the range of 20,000-4,000,000,

where the adhesive has excellent initial adhesiveness as well as excellent peeling ability, and does not produce stickiness.

The term “initial adhesiveness” refers to the adhesive force in which the adhesive is in a wet state immediately after it has been applied to the roll-shaped paper. The term “peeling ability” refers to an index which shows the ease of peeling the roll-shaped paper from the core after the adhesive which has been applied in order to paste the roll-shaped paper to the core has completely dried.

The adhesive for roll-shaped paper of this invention has an excellent initial adhesiveness when the saccharide (A) also contains maltose.

When the aqueous polymers with weight average molecular weights in the range of 20,000-4,000,000 in the adhesive for roll-shaped paper of this invention include vinyl pyrrolidone polymers with weight average molecular weights in the range of 25,000-400,000 and/or alkylene oxide polymers with weight average molecular weights in the range of 300,000-3,500,000, the initial tack becomes higher and therefore the initial adhesiveness becomes higher.

The adhesive for roll-shaped paper of this invention is applied at the start of the winding of the roll-shaped paper and it can be used in a useful manner as a pick-up agent.

Because the aforementioned adhesive for roll-shaped paper is applied to the roll-shaped paper of this invention, the paper is quickly pasted to the core and the peeling ability of the paper is increased.

Since the aforementioned adhesive for roll-shaped paper of this invention is applied at the start of the winding of the roll-shaped paper, the roll-shaped paper of this invention can be easily peeled from the core.

The adhesive for roll-shaped paper of this invention comprises a saccharide (A), a viscosity modifier (B), and a glycol and/or triol (C).

In this invention, the “saccharide (A)” contains glucose as a necessary ingredient; it is not particularly limited to glucose, as long as the adhesive for roll-shaped paper which is the purpose of this invention can be obtained. “Glucose” is a typical monosaccharide, which is also called “grape sugar.” The saccharide (A) may be only glucose, but it is desirable for it to include other saccharides. Examples of the other saccharides are monosaccharides (other than glucose), disaccharides, trisaccharides, tetrasaccharides, and other oligosaccharides.

The following are specific examples of the monosaccharides other than glucose:
hexoses, such as psicose, fructose, sorbose, tagatose, allose, altrose, mannose, gulose, idose, galactose, talose, fucose, fucrose [sic], ramunose, etc.;
trioses, such as ketotriose (dihydroxyacetone), aldotriose (glyceraldehyde), etc.;
tetroses, such as eiritriose [sic], erithryose, threose, etc.; and
pentoses, such as riburose, xylulose, ribose, arabinose, xylose, lyxose, deoxyribose, etc.

Examples of the disaccharides are sucrose, lactose, maltose, trehalose, turanose, and cellobiose; examples of the trisaccharides are raffinose, ereditose [sic], and maltotriose; and examples of the tetrasaccharides are acarbose and stachyose.

Examples of the polysaccharides are glycogen, starches (amylose and amylopectin), cellulose, dextrin glucan, N-acetylglucosamine, and chitin.

Examples of other oligosaccharides are fructo-oligosaccharides, galacto-oligosaccharides, and mannan oligosaccharides.

These other saccharides can be used individually or in combinations.

As the other saccharides, monosaccharides other than glycol and disaccharides are desirable, and maltose is desirable as a disaccharide.

Therefore, it is preferable for the adhesive for roll-shaped paper of this invention to contain glucose and maltose as the saccharide (A).

To make the adhesive, the saccharide (A) is mixed with a viscosity modifier (B) and a glycol and/or triol (C); the saccharide (A) may be mixed in a solid state, or it may be dissolved in water to make a liquid sugar (syrup) before being mixed with the viscosity modifier (B) and glycol and/or triol (C).

The viscosity modifier (B) contains aqueous polymers with weight average molecular weights in the range of 20,000-4,000,000. They are not particularly limited, as long as the adhesive for roll-shaped paper which is the purpose of this invention can be obtained. In this invention, examples of the water-soluble polymers included in the viscosity modifier (B) are vinyl pyrrolidone and alkylene oxide polymers and polyvinyl alcohol.

It is desirable for the aqueous polymers with weight average molecular weights to be in the range of 20,000-4,000,000 to be vinyl pyrrolidone polymers with weight average molecular weights in the range of 25,000-400,000 and/or alkylene oxide polymers with weight average molecular weights in the range of 300,000-3,500,000. Such vinyl pyrrolidone and alkylene oxide polymers may be used individually or in mixtures.

The weight average molecular weights of the vinyl pyrrolidone polymers to be in the range of 25,000-400,000, and more desirable for them to be in the range of 200,000-400,000. If the weight average molecular weights are in the range of 25,000-400,000, the initial adhesiveness of the adhesive for roll-shaped paper will be higher.

It is desirable for the weight average molecular weights of the alkylene oxide polymers to be in the range of 300,000-3,500,000, and more desirable for them to be in the range of 300,000-2,000,000. If the weight average molecular weights are in the range of 300,000-3,500,000, the initial adhesiveness of the adhesive for roll-shaped paper will be increased.

The weight average molecular weight (Mw) refers to the weight average molecular weight which is measured by a gel permeation chromatograph (GPC) and calculated by the monodispersed molecular weight distribution of polyethylene glycol. More specifically, the RI and UV chromatograms were detected using Waters 2690, 2487, and 410. For the GPC column, TSKgel SuperMultipore PWXL, Ultrahydrogel Linear, TSKgel MPWXL, and Ultrahydrogel 250 (Tosoh Co.) were used.

The samples were dissolved in acetonitrile/0.1M pH 7.0 phosphate buffer solution (20:80), the flow rate was 0.6 ml/min, and the column temperature was 40° C.

Furthermore, the Mw were obtained by using the calibration curves obtained by using, as the standard substances, a total of three kinds: an ethylene glycol (EG) solution and 7 standard polyethylene oxide (PEO)/polyethylene glycol (PEG) with different molecular weights were used to prepare 2 PEO/PEG solutions (“STD-A” and “STD-B” below). Here the STD-A was obtained by mixing PEOs with Mw=920,000, 107,000, and 24,000 and a PEG with Mw=1,500. The STD-B was obtained by mixing PEOs with Mw=250,000 and 50,000 and a PEG with Mw=3,000.

In this invention, the term “vinyl pyrrolidone polymers” refers to polymers with vinyl pyrrolidone units obtained from N-vinyl pyrrolidone; they are not particularly limited as long as the adhesive for rolled paper which is the purpose of this invention can be obtained. Non-limiting examples of vinyl pyrrolidone polymers include homopolymers with polyvinyl pyrrolidone or N-vinyl pyrrolidone or copolymer of the aforementioned and/or other monomers.

When the vinyl pyrrolidone polymers are copolymers, the monomers which are copolymerized with the N-vinyl pyrrolidone are ones which can be copolymerized with N-vinyl pyrrolidone; they are not particularly limited as long as the adhesive for rolled paper which is the purpose of this invention can be obtained.

Specific examples of such monomers include:

(1) (meth)acrylic acid esters, such as methyl (meth)acrylate, ethyl (meth)acrylate, butyl (meth)acrylate, (meth)acrylic acid-2-hydroxyethyl, etc.;

(2) (meth)acrylamide derivatives, such as (meth)acrylic acid amide, N-monoethyl (meth)acrylamide, N,N′-dimethyl (meth)acrylamide, 2-acrylamide-2-methylpropane sulfuric acid, etc.;

(3) basic unsaturated monomers, such as dimethylaminoethyl (meth)acrylate, dimethylaminoethyl (meth)acrylamide, vinylpyridine, vinylimidazole, etc.;

(4) vinyl amides, such as vinyl formamide, vinyl acetamide, vinyl oxazolidone, N-vinyl caprolactam, etc.;

(5) unsaturated monomers containing the carboxyl group, such as (meth)acrylic acid, itaconic acid, maleic acid, fumaric acid, etc.;

(6) unsaturated acid anhydrides, such as maleic anhydride, itaconic anhydride, etc.;

(7) vinyl esters, such as vinyl propionate, vinyl acetate, etc.;

(8) vinyl ethylene carbonate and its derivatives;

(9) styrene and its derivatives;

(10) vinylsulfonic acid and its derivatives;

(11) vinyl ethers, such as ethyl vinyl ether; and

(12) olefins, such as ethylene, propylene, butadiene, etc.

The alkylene oxide polymers are polymers with alkylene oxide units derived from alkylene oxide; they are not particularly limited as long as the adhesive for rolled paper which is the purpose of this invention can be obtained.

Examples of such alkylene oxides are ethylene oxide, propylene oxide, and butylene oxide. Among these alkylene oxides, ethylene oxide is preferable in this invention.

In this invention, the alkylene oxide polymers may be copolymers of alkylene oxide and other monomers. The monomers which are copolymerized with alkylene oxide are not particularly limited as long as the adhesive for rolled paper which is the purpose of this invention can be obtained, but it is desirable for them to be unsaturated carboxylic acid monomers and/or their salts. Examples of the unsaturated carboxylic acid monomers are acrylic acid, methacrylic acid, acryloxypropionic acid, citraconic acid, itaconic acid, crotonic acid, maleic acid, maleic anhydride, etc. Moreover, examples of the salts of unsaturated carboxylic acid monomers are metal salts, such as sodium salts and potassium salts, ammonium salts, etc., of the aforementioned unsaturated carboxylic acid monomers.

The viscosity modifier (B) includes the aforementioned aqueous polymers; it increases the initial adhesiveness of the adhesive for roll-shaped paper. In this invention, it is ideal to use viscosity modifiers (B) made by the Sumitomo Seika Chemicals Co. (trade names: PEO #2, PEO #3Z, PEO #8Z, and PEO #15Z) or ones made by the Nippon Catalytic Chemical Co. (trade names: PVP K-30, PVP K-90, PVP K-85).

As long as the adhesive for rolled paper which is the purpose of this invention can be obtained, the viscosity modifier (B) may include, besides vinyl pyrrolidone or alkylene oxide polymers, those that are generally used as viscosity modifiers, such as nitrogen-containing substances, such as urea, urea compounds, dicyandiamide, etc., and calcium hydroxide, calcium oxide, sodium carbonate, trisodium phosphate, diammonium hydrogen phosphate, borax, sodium fluoride, water glass, ammonia water, etc.

The adhesive for roll-shaped paper of this invention contains a glycol and/or triol (C).

The “glycol and/or triol (C)” in this invention refers to glycols and/or triols with Mw less than 20,000; they are not particularly limited as long as the adhesive for rolled paper which is the purpose of this invention can be obtained, but it is desirable for them to be liquid at ordinary temperatures and pressures and to be able to dissolve the saccharide (A) and the viscosity modifier (B). It is more desirable for them to be glycols.

Examples of the glycols and/or triols (C) are:

triols, such as glycerol, or

glycols such as ethylene glycol, dipropylene glycol, propylene glycol, diethylene glycol, triethylene glycol, polyethylene glycol, polypropylene glycol, etc.

They can be used individually or in combinations.

(C) may be a polyalkylene glycol such as polyethylene glycol or polypropylene glycol, but since its Mw is less than 20,000, this is different from the alkylene oxide polymers contained in the viscosity modifier (B).

Furthermore, the glycols and/or triols (C) are used as stickiness regulating agents. The glycols and/or triols (C) may be used as is or they may be used by mixing them with solvents. These solvents may be any aqueous or non-aqueous solvents, or mixtures of both, but it is preferable for them to be solvents which contain aqueous solvents and it is still more preferable for them to be aqueous solvents.

The aforementioned saccharide (A), viscosity modifier (B), and glycols and/or triols (C) may be mixed as is, for example, in the solid or liquid states, but if necessary they may be dissolved in or mixed with aqueous solvents. The mixtures obtained may be further adjusted to the desired concentrations by using aqueous solvents to obtain the adhesive for roll-shaped paper of this invention. Therefore, the adhesive for roll-shaped paper of this invention is generally an aqueous adhesive. It is preferable that the adhesive for roll-shaped paper to dissolve uniformly in an aqueous solvent.

Here, the term “aqueous solvent” refers to general kinds of water, such as tap water, distilled water, or deionized water, but it may also include organic solvents which have little reactivities with the ingredients of the adhesive of this invention, for example, acetone, ethyl acetate, etc. It may also include monomers, oligomers, prepolymers, and/or resins which are soluble in aqueous solvents. Moreover, it may also include the various kinds of additives mentioned below.

In this invention, it is desirable for the saccharide (A) to be, as a solid, in the range of 10-90 parts by weight, preferably 20-70 parts by weight, and especially preferably 40-60 parts by weight, per 100 parts by weight of the total of (A)-(C). If the adhesive for roll-shaped papers contains the saccharide (A) in the range of 10-90 parts by weight per 100 parts by weight of the total of (A)-(C), the balance of initial adhesiveness and peeling ability will be excellent and unnecessary stickiness will not be produced.

In this invention, it is desirable for the viscosity modifier (B) to be, as a solid, in the range of 1-10 parts by weight, preferably 1-8 parts by weight, and especially preferably 1-7 parts by weight, per 100 parts by weight of the total of (A)-(C). If the adhesive for roll-shaped papers contains the viscosity modifier (B) in the range of 1-10 parts by weight per 100 parts by weight of the total of (A)-(C), the balance of initial adhesiveness and peeling ability will be excellent and unnecessary stickiness will not be produced.

In this invention, it is desirable for the glycols and/or triols (C) to be in the range of 10-70 parts by weight, preferably 20-70 parts by weight, and especially preferably 20-60 parts by weight, per 100 parts by weight of the total of (A)-(C). If the adhesive for roll-shaped papers contains the glycols and/or triols (C) in the range of 10-70 parts by weight per 100 parts by weight of the total of (A)-(C), the balance of initial adhesiveness and peeling ability will be excellent and unnecessary stickiness will not be produced.

In this invention, it is desirable for the total weight of ingredients (A)-(C) to be in the range of 10-90 parts by weight, preferably 30-90 parts by weight, and especially preferably 40-80 parts by weight, per 100 parts by weight of the total of the adhesive for roll-shaped paper. If the total weight of ingredients (A)-(C) is in the range of 10-90 parts by weight, the balance of initial adhesiveness and peeling ability of the adhesive for roll-shaped paper of this invention will be excellent and unnecessary stickiness will not be produced.

The adhesive for roll-shaped paper of this invention can include suitable additives, such as cross-linking agents, plasticizers, foam quenchers, anti-rust agents, preservatives, etc., if necessary, besides the ingredients (A)-(C). The methods for compounding the additives are not particularly limited.

When the adhesive for roll-shaped paper of this invention is prepared, after the ingredients (A)-(C) and, if necessary, various additives are compounded, an aqueous solvent may be added, or the ingredients (A)-(C) may be mixed with an aqueous solvent beforehand, after which the various additives may be added.

Among the various kinds of additives, examples of the cross-linking agents are zinc acetate, zinc oxide, zirconium acetate, zirconium ammonium carbonate, etc. These cross-linking agents can be used individually or in combinations.

Examples of the foam quenchers are:

silicone foam quenchers, such as dimethylpolysiloxane, polyoxyakylene-modified silicone, organic-modified polysiloxane, fluorine silicone, etc.;

oil foam quenchers, such as castor oil, sesame oil, flaxseed oil, etc.;

fatty acid foam quenchers, such as stearic acid, oleic acid, palmitic acid, etc.;

fatty acid ester foam quenchers, such as isoamyl stearic acid, diglycol lauric acid, distearyl succinic acid, distearic acid, sorbitan monolauric acid, glycerol fatty acid ester, sorbitan fatty acid ester, polyoxyethylene sorbitan, monolauric acid butyl stearate, sucrose fatty acid ester, sulfonated ricinolic acid ethyl acetate alkyl ester, natural waxes, etc.;

alcohol foam quenchers, such as polyoxyalkyene glycol and its derivatives, polyoxyalkylene alcohol hydrate, diamyl phenoxyethanol, 3-heptanol, 2-ethylhexanol, etc.;

ether foam quenchers, such as 3-heptyl Cellosolve, nonyl Cellosolve-3-heptylcarbitol, etc.;

phosphate foam quenchers, such as tributyl phosphate, sodium octyl phosphate, tris(butoxyethyl) phosphate, etc.;

amine foam quenchers, such as diamylamine;

amide foam quenchers, such as polyalkylene amide, acylate polyamine, dioctadecanoyl piperidine, etc.;

metal soap foam quenchers, such as aluminum stearate, calcium stearate, potassium oleate, calcium salt of wool olein, etc.; and

sulfonate foam quenchers, such as sodium lauryl sulfonate, sodium dodecyl sulfonate, etc.

It is preferable for the adhesive for roll-shaped paper of this invention to contain silicone foam quenchers as foam quenchers. Since silicone foam quenchers are better for the skin than other foam quenchers, they are preferable for adhesives for roll-shaped paper which are applied to toilet papers or kitchen papers.

The adhesive for roll-shaped paper of this invention is used by applying it to paper which is rolled in a roll shape. The roll-shaped paper may be [any] papers which are rolled into a roll shape, but generally thin hygienic papers such as toilet paper or kitchen papers are rolled into a roll shape. The papers rolled into a roll shape may be one-ply papers, but it is preferable for them to be 2-ply papers or ones with more layers, from the point of view of water absorbability.

The part on which the adhesive for roll-shaped paper is applied may be any part of the roll-shaped paper, but it is ideal for applying the adhesive the start of the winding or the tail sheet part (the end of the winding). The adhesive for roll-shaped paper of this invention is especially effective if it is used as a pick-up agent, which is applied at the start of the winding of the roll-shaped paper.

The term “pick-up agent” herein refers to aqueous adhesives which are applied when the winding of the paper on the core is started. Pick-up agents are used to facilitate the peeling of the paper from the core.

The roll-shaped paper of this invention is toilet paper, kitchen paper, etc., to which the aforementioned adhesive for roll-shaped paper is applied; it is especially desirable for it to be applied at the start of the winding of the roll-shaped paper or to the tail sheet (the end of the winding), and it is especially favorable in this invention if it is applied at the start of the winding.

The most desirable working embodiment of the roll-shaped paper of this invention is toilet paper to which the adhesive for roll-shaped paper is applied as a pick-up agent, especially toilet paper with a core.

It is not necessary to employ any special method for applying the adhesive for roll-shaped paper of this invention. Methods which are generally used, such as wheel, blade, mount, nozzle, spray, etc., methods may be used.

Since an adhesive for roll-shaped paper with a high initial adhesiveness is applied, the core of the roll-shaped paper and the paper are quickly pasted. Furthermore, since an adhesive for roll-shaped paper with excellent peeling ability is applied to the roll-shaped paper, the paper can be easily peeled from the core (the part at the beginning of the winding) or the tail sheet (the part and the end of the winding), and it is used without wasting it until the end.

### EXAMPLES

This invention will be explained below by using working and comparison examples, but these examples are used for explaining this invention and do not limit it in any way.

First, the following ingredients were prepared as the ingredients of the adhesive for roll-shaped paper. The names of the products and manufacturers are put into parentheses. Furthermore, “parts” means parts by weight, and “molecular weight” means the weight average molecular weight (Mw).

Saccharide (A):
(A-1) Glucose (glucose TDH, San'ei Toka Co.)
(A-2) Liquid sugar (San-Syrup R75, Nihon Cornstarch Co.) (San-Syrup R75 is an aqueous solution of glucose, maltose, and other saccharides dissolved in water at a concentration of 75 wt %)
(A′-3) Dextrin (Dextrin Mw=75,000, Wako Pure Chemical Industries, Ltd.)
(A′-4) Carboxymethyl cellulose (CMC 1205, Daicel Chemical Industries Co.)
(A′-5) Methyl cellulose (Maaporouzu 90EMP4000, Matsumoto Yushi-Seiyaku Co.)

Viscosity Modifier (B):

### Polyvinyl Pyrrolidone

(B-1) (PVPK-30, Mw=25,000, Nippon Shokubai Co.)
(B-2) (PVPK-85, Mw=250,000, Nippon Shokubai Co.)
(B-3) (PVPK-90, Mw=400,000, Nippon Shokubai Co.)

### Polyethylene Oxide

(B-4) (PEO #2, Mw=350,000, Sumitomo Seika Co.)
(B-5) (PEO #3Z, Mw=340,000, Sumitomo Seika Co.)
(B-6) (PEO #8Z, Mw=2,000,000, Sumitomo Seika Co.)
(B-7) (PEO #15Z, Mw=23,500,000, Sumitomo Seika Co.)

### Polyvinyl Alcohol

(B-8) (JP-33, Mw=145,000, Nihon Vinyl Acetate Poval Co.)

Glycols and/or Triols (C):
(C-1) Diethylene glycol (Diethylene glycol, Wako Pure Chemical Industries, Ltd.)
(C-2) Triethylene glycol (Triethylene glycol, Wako Pure Chemical Industries, Ltd.)
(C-3) Dipropylene glycol (Dipropylene glycol, Wako Pure Chemical Industries, Ltd.)
(C-4) Polyalkylene glycol (Unilub 75DE170, Mw=5,000, Nichiyu Co.)

### Foam Quencher:

(D-1) Silicone foam quencher (KM72-F, Shin'etsu Kagaku Kogyo Co.)

The adhesives for roll-shaped paper of Working Examples 1-17 were made using the following formulas and compounding conditions.

### Working Example 1

Forty parts water, 44 parts (A-1), 6 parts (B-3), and 50 parts (C-1) were added to a flask provided with a stirrer, heated to 60° C., and stirred for 1 hour. One hundred forty parts of a mixture of water, saccharide, viscosity modifier, and glycol were obtained. The mixture liquid was cooled to room temperature (23° C.) and 1 part (D-1) was added, after which the mixture was stirred for 30 minutes and the adhesive for roll-shaped paper of Working Example 1 was obtained.

### Working Example 2

The adhesive for roll-shaped paper of Working Example 2 was obtained by using the same method as in Working Example 1 except that 59 parts (A-2) were used instead of the 44 parts of (A-1).

### Working Example 3

The adhesive for roll-shaped paper of Working Example 3 was obtained by using the same method as in Working Example 1 except that (B-6) was used instead of the (B-3).

### Working Example 4

The adhesive for roll-shaped paper of Working Example 4 was obtained by using the same method as in Working Example 3 except that 59 parts (A-2) were used instead of the 44 parts of (A-1).

### Working Example 5

The adhesive for roll-shaped paper of Working Example 5 was obtained by using the same method as in Working Example 1 except that (B-1) was used instead of the (B-3).

### Working Example 6

The adhesive for roll-shaped paper of Working Example 6 was obtained by using the same method as in Working Example 1 except that (B-2) was used instead of the (B-3).

### Working Example 7

The adhesive for roll-shaped paper of Working Example 7 was obtained by using the same method as in Working Example 1 except that (B-5) was used instead of the (B-3).

### Working Example 8

The adhesive for roll-shaped paper of Working Example 8 was obtained by using the same method as in Working Example 1 except that (B-4) was used instead of the (B-3).

### Working Example 9

The adhesive for roll-shaped paper of Working Example 9 was obtained by using the same method as in Working Example 1 except that (B-7) was used instead of the (B-3).

### Working Example 10

The adhesive for roll-shaped paper of Working Example 10 was obtained by using the same method as in Working Example 1 except that (C-2) was used instead of the (C-1).

### Working Example 11

The adhesive for roll-shaped paper of Working Example 11 was obtained by using the same method as in Working Example 1 except that (C-3) was used instead of the (C-1).

### Working Example 12

The adhesive for roll-shaped paper of Working Example 12 was obtained by using the same method as in Working Example 1 except that (C-4) was used instead of the (C-1).

### Working Example 13

The adhesive for roll-shaped paper of Working Example 13 was obtained by using the same method as in Working Example 2 except that (C-2) was used instead of the (C-1).

### Working Example 14

The adhesive for roll-shaped paper of Working Example 14 was obtained by using the same method as in Working Example 2 except that (C-3) was used instead of the (C-1).

### Working Example 15

The adhesive for roll-shaped paper of Working Example 15 was obtained by using the same method as in Working Example 2 except that (C-4) was used instead of the (C-1).

### Working Example 16

The adhesive for roll-shaped paper of Working Example 16 was obtained by using the same method as in Working Example 1 except that the quantity of (A-1) was changed from 44 parts to 70 parts, the quantity of (C-1) was changed from 50 parts to 26.8 parts, and the quantity of (B-3) was changed from 6 parts to 3.2 parts.

### Working Example 17

The adhesive for roll-shaped paper of Working Example 17 was obtained by using the same method as in Working Example 1 except that the quantity of (A-1) was changed from 44 parts to 30 parts and the quantity of (C-1) was changed from 50 parts to 64 parts.

The compositions of 141 parts of the adhesives for roll-shaped paper of Working Examples 1-17 (including 1 part foam quencher) are shown in Table 1.

TABLE 1

| | Working Examples | | | | | | | | | | | | | | | | |
|---|---|---|---|---|---|---|---|---|---|---|---|---|---|---|---|---|---|
| | 1 | 2 | 3 | 4 | 5 | 6 | 7 | 8 | 9 | 10 | 11 | 12 | 13 | 14 | 15 | 16 | 17 |
| (A-1) | 44 | | 44 | | 44 | 44 | 44 | 44 | 44 | 44 | 44 | 44 | | | | 70 | 70 |
| (A-2) | | 59 | | 59 | | | | | | | | | 59 | 59 | 59 | | |
| * | | 44 | | 44 | | | | | | | | | 44 | 44 | 44 | | |
| (A′-3) | | | | | | | | | | | | | | | | | |
| (A′-4) | | | | | | | | | | | | | | | | | |
| (A′-5) | | | | | | | | | | | | | | | | | |
| (B-1) | | | | | 6 | | | | | | | | | | | | |
| (B-2) | | | | | | 6 | | | | | | | | | | | |
| (B-3) | 6 | 6 | | | | | | | | 6 | 6 | 6 | 6 | 6 | 6 | 3.2 | 6 |
| (B-4) | | | | | | | | 6 | | | | | | | | | |
| (B-5) | | | | | | | 6 | | | | | | | | | | |
| (B-6) | | | 6 | 6 | | | | | | | | | | | | | |
| (B-7) | | | | | | | | | 6 | | | | | | | | |
| (B-8) | | | | | | | | | | | | | | | | | |
| (C-1) | 50 | 50 | 50 | 50 | 50 | 50 | 50 | 50 | 50 | | | | | | | 26.8 | 64 |
| (C-2) | | | | | | | | | | 50 | | | 50 | | | | |
| (C-3) | | | | | | | | | | | 50 | | | 50 | | | |
| (C-4) | | | | | | | | | | | | 50 | | | 50 | | |
| Water | 40 | 25 | 40 | 25 | 40 | 40 | 40 | 40 | 40 | 40 | 40 | 40 | 25 | 25 | 25 | 40 | 40 |
| (D-1) | 1 | 1 | 1 | 1 | 1 | 1 | 1 | 1 | 1 | 1 | 1 | 1 | 1 | 1 | 1 | 1 | 1 |

* Quantity of saccharide contained in (A-2). In Table 1, 44 parts by weight saccharide and 15 parts by weight water are contained in 59 parts by weight of (A-2)

The adhesives for roll-shaped paper of Comparison Examples 1-9 were made using the following formulas and compounding conditions.

### Comparison Example 1

Forty parts water, 50 parts (A-1), and 50 parts (C-1) were added to a flask provided with a stirrer, heated to 60° C., and stirred for 1 hour. One hundred forty parts of a mixed liquid were obtained. The mixed liquid was cooled to room temperature (23° C.) without adding a viscosity modifier (B), after which 1 part (D-1) was added and stirring was performed for 30 minutes to obtain the adhesive for roll-shaped paper of Comparison Example 1.

### Comparison Example 2

The adhesive for roll-shaped paper of Comparison Example 2 was obtained by using the same method as in Comparison Example 1 except that 67 parts (A-2) were added instead of the 50 parts of (A-1) and the quantity of water added was changed from 40 parts to 25 parts.

### Comparison Example 3

The adhesive for roll-shaped paper of Comparison Example 3 was obtained by using the same method as in Comparison Example 1 except that (A′-3) was used instead of (A-1).

### Comparison Example 4

The adhesive for roll-shaped paper of Comparison Example 4 was obtained by using the same method as in Comparison Example 1 except that (A′-3) was used instead of (A-1).

### Comparison Example 5

The adhesive for roll-shaped paper of Comparison Example 5 was obtained by using the same method as in Comparison Example 3 except that (A′-3) was used instead of (A-1).

### Comparison Example 6

The adhesive for roll-shaped paper of Comparison Example 6 was obtained by using the same method as in Working Example 1 except that (A′-4) was used instead of (A-1) and the quantity of water added was changed from 40 parts to 880 parts. Since (A′-4) did not dissolve completely when 40 parts of water were added, the quantity of water added was increased and the viscosity was adjusted.

### Comparison Example 7

The adhesive for roll-shaped paper of Comparison Example 7 was obtained by using the same method as in Working Example 1 except that (A′-5) was used instead of (A-1) and the quantity of water added was changed from 40 parts to 880 parts. As in Comparison Example 6, the quantity of water added was increased and the viscosity was adjusted.

### Comparison Example 8

The adhesive for roll-shaped paper of Comparison Example 8 was obtained by using the same method as in Working Example 1 except that (A′-4) was used instead of (A-1) and the quantity of water added was changed from 40 parts to 880 parts. As in Comparison Example 6, the quantity of water added was increased and the viscosity was adjusted.

### Comparison Example 9

Forty parts water, 79 parts (A-1), and 21 parts (B-3) were added to a flask provided with a stirrer, heated to 60° C., and stirred for 1 hour; a mixture was obtained. The mixture was cooled to room temperature and 1 part (D-1) was added, after which the mixture was stirred for 30 minutes and the adhesive for roll-shaped paper of Comparison Example 9 was obtained.

The compositions of the adhesives for roll-shaped paper of Comparison Examples 1-9 (including 1 part foam quencher) are shown in Table 2.

TABLE 2

| | Comparison Examples | | | | | | | | |
|---|---|---|---|---|---|---|---|---|---|
| | 1 | 2 | 3 | 4 | 5 | 6 | 7 | 8 | 9 |
| (A-1) | 50 | | | | | | | | 79 |
| (A-2) | | 67 | | | | | | | |
| * | | 50 | | | | | | | |
| (A′-3) | | | 50 | 44 | 44 | | | | |
| (A′-4) | | | | | | 44 | | | |
| (A′-5) | | | | | | | 44 | | |
| (B-1) | | | | | | | | | |
| (B-2) | | | | | | | | | |
| (B-3) | | | | 6 | | 6 | 6 | 6 | 21 |
| (B-4) | | | | | | | | | |
| (B-5) | | | | | | | | | |
| (B-6) | | | | | 6 | | | | |
| (B-7) | | | | | | | | | |
| (B-8) | | | | | | | | 44 | |
| (C-1) | 50 | 50 | 50 | 50 | 50 | 50 | 50 | 50 | |
| (C-2) | | | | | | | | | |
| (C-3) | | | | | | | | | |
| (C-4) | | | | | | | | | |
| Water | 40 | 25 | 40 | 40 | 40 | 880 | 880 | 440 | 40 |
| (D-1) | 1 | 1 | 1 | 1 | 1 | 1 | 1 | 1 | 1 |

* Quantity of saccharide contained in (A-2). In Table 2, 50 parts by weight saccharide and 17 parts by weight water are contained in 67 parts by weight of (A-2)

Evaluation tests were performed on the adhesives for roll-shaped paper of the working and comparison examples. The test methods and evaluation standards are given below.

### Peeling Ability Test

The adhesives for roll-shaped paper of the working and comparison examples were applied to the original paper of paper tubes for commercial toilet paper rolls (quantity applied: 70-80 g/m2 wet), using a bar coater No. 40 (Nihon Coating Tester Co.), and the paper tubes were bonded with commercial roll-shaped paper for 2-ply toilet paper. After drying for 24 hours at room temperature (23° C.), the peeling ability of the adhesive was evaluated.

### Evaluation Standards

O: the paper could be easily peeled from the paper tube without being torn

Δ: the paper tore slightly when peeled from the paper tube

X: the paper tore when peeled from the paper tube

### Initial Adhesiveness Test

The adhesives for roll-shaped paper of the working and comparison examples were applied to commercial roll-shaped paper for 2-ply toilet paper under thin application and thick application conditions. The tack levels of the adhesives applied under each of the application conditions were evaluated immediately after the application at room temperature by means of a finger test.

Thin application conditions: 13-14 g/m2 wet were applied using a bar coater No. 6 (Nihon Coating Tester Co.).

Thick application conditions: 130-140 g/m2 wet were applied using a bar coater No. 70 (Nihon Coating Tester Co.).

### Evaluation Standards

□: very strong tack

O: strong tack

Δ: some tack

X: no tack at all

### Stickiness Test

The adhesives for roll-shaped paper of the working and comparison examples were applied to the original paper of paper tubes (quantity applied: 130-140 g/m2 wet), using a bar coater No. 70 (Nihon Coating Tester Co.), and the paper tubes were bonded with commercial roll-shaped paper for 2-ply toilet paper. After the samples were left at room temperature (23° C.) for 24 hours, and after the paper tubes and the roll-shaped paper for 2-ply toilet paper were peeled apart, the tack level of the surface on which the adhesive was applied was evaluated by means of a finger test.

### Evaluation Standards

□: no stickiness at all

O: almost no stickiness

Δ: some stickiness

X: stickiness present

The results of evaluating of the adhesives for roll-shaped paper of Working Examples 1-17 and Comparison Examples 1-9 in the peeling ability test, initial adhesiveness test, and stickiness test are shown in Tables 3 and 4.

TABLE 3

| | Working Example | | | | | | | | | | | | | | | | |
|---|---|---|---|---|---|---|---|---|---|---|---|---|---|---|---|---|---|
| | 1 | 2 | 3 | 4 | 5 | 6 | 7 | 8 | 9 | 10 | 11 | 12 | 13 | 14 | 15 | 16 | 17 |
| Peeling | ◯ | ◯ | ◯ | ◯ | ◯ | ◯ | ◯ | ◯ | ◯ | ◯ | ◯ | ◯ | ◯ | ◯ | ◯ | ◯ | ◯ |
| ability | | | | | | | | | | | | | | | | | |
| Initial | [symbol] | [symbol] | [symbol] | [symbol] | ◯ | [symbol] | [symbol] | ◯ | [symbol] | [symbol] | [symbol] | [symbol] | [symbol] | [symbol] | [symbol] | [symbol] | [symbol] |
| adhesiveness | | | | | | | | | | | | | | | | | |
| Stickiness | [symbol] | [symbol] | [symbol] | [symbol] | ◯ | ◯ | ◯ | ◯ | ◯ | [symbol] | [symbol] | ◯ | [symbol] | [symbol] | ◯ | ◯ | ◯ |

TABLE 4

| | Comparison Example | | | | | | | | |
|---|---|---|---|---|---|---|---|---|---|
| | 1 | 2 | 3 | 4 | 5 | 6 | 7 | 8 | 9 |
| Peeling | ◯ | ◯ | Δ | X | X | Δ | Δ | Δ | ◯ |
| ability | | | | | | | | | |
| Initial | X | X | X | [symbol] | [symbol] | Δ | Δ | Δ | ◯ |
| adhesiveness | | | | | | | | | |
| Stickiness | Δ | Δ | Δ | [symbol] | [symbol] | ◯ | ◯ | ◯ | X |

As shown in Tables 1 and 3, the adhesives of Working Examples 1-17 had excellent peeling abilities and initial adhesivenesses and did not produce stickiness. The adhesives which maintain a good balance of these functions are effective as adhesives for roll-shaped paper, especially pick-up adhesives.

The adhesives of Comparison Examples 1-9, as shown in Tables 2 and 4, had problems in peeling ability, initial adhesiveness, and stickiness.

Since the adhesives of Comparison Examples 1-3 did not contain ingredient (B), their initial adhesivenesses were lowered. Since the adhesives of Comparison Examples 4-8 did not contain (A-1) or (A-2), the glucose ingredient, their peeling abilities were inferior to the adhesives of the working examples. Since the adhesives of Comparison Examples 4 and 5 contained the dextrin (A′-3) as a saccharide but did not contain glucose, their peeling abilities were lowered. Since the adhesives of Comparison Examples 6 and 7 contained the carboxymethyl cellulose (A′-4) or methyl cellulose (A′-5) as saccharides but did not contain glucose, their peeling abilities and initial adhesivenesses were lowered. Comparison Example 8 contained polyvinyl alcohol but did not contain any saccharides; it had poor peeling ability and initial adhesiveness. Since Comparison Example 9 did not contain ingredient (C), stickiness was produced.

From these results, it is clear that the three ingredients (A)-(C) are necessary ingredients for the adhesive for roll-shaped paper to have an excellent performance.

1. An adhesive for roll-shaped paper comprising:
a saccharide (A);
a viscosity modifier (B); and
a glycol and/or triol (C).

2. The adhesive of claim 1, wherein the:
the saccharide (A) contains glucose, and
the viscosity modifier (B) contains aqueous polymers with weight average molecular weights in the range of 20,000-4,000,000.

3. The adhesive of claim 2, wherein the saccharide (A) further comprises maltose.

4. The adhesive of claim 2, wherein the aqueous polymers comprises vinyl pyrrolidone polymers with weight average molecular weights in the range of 25,000-400,000 and/or alkylene oxide polymers with weight average molecular weights in the range of 300,000-3,500,000.

5. A roll-shaped paper comprising the adhesive of claim 1.

6. A roll-shaped paper comprising the adhesive of claim 2.

7. A roll-shaped paper comprising the adhesive of claim 3.

8. A roll-shaped paper comprising the adhesive of claim 4.

9. The roll-shaped paper of claim 5 wherein the adhesive is applied at the start of the winding of the roll-shaped paper.
